(19) United States
(12) Patent Application Publication
(10) Pub. No.: US 2011/0115639 A1
(43) Pub. Date: May 19, 2011

(54) INTEGRITY MONITORED CONCRETE PILINGS

(75) Inventor: Kurt Hecht, New Hope, PA (US)

(73) Assignee: SMART STRUCTURES, INC., Southampton, PA (US)

(21) Appl. No.: 12/945,233

(22) Filed: Nov. 12, 2010

Related U.S. Application Data
(60) Provisional application No. 61/260,995, filed on Nov. 13, 2009.

(51) Int. Cl. G08B 5/00; E02D 5/00; G01L 1/00; G06F 19/00

(52) U.S. Cl. 340/815.4; 405/256; 702/42

(57) ABSTRACT

A pile having first and second strain gauges installed in the piling core near and at the piling tip is provided. The second strain gauge is placed co-linear and at a known and controlled distance up the pile from the first strain gauge. Independent strain gauge measurements are made and transmitted to a controller, which receives signals from the strain gauges and compares them to static pre-stress levels that are initially established after casting and prior to pile installation. The dynamic force measurements are checked against expected ranges to assess pile tip integrity as well as other parameters.

### CROSS REFERENCE TO RELATED APPLICATIONS

This application claims the benefits of U.S. Provisional Patent Application No. 61/260,995, filed Nov. 13, 2009, which is incorporated herein by reference as if fully set forth.

### BACKGROUND

The invention relates to concrete pilings and structures having gauges and sensors pre-cast therein.

The assignee has developed concrete pilings that have strain gauges and accelerometers embedded at the piling top and the piling tip. A radio is also embedded to transmit the sensor signals from the piling so that driving of the piling can be monitored and/or controlled during pile installation. The prior known pilings are described in U.S. Pat. No. 6,533,502, which was developed by the University of Florida and is licensed to the Assignee, as well as US2006/0021447 and US2007/0151103 which were developed by the assignee, the contents of which are incorporated herein by reference as if fully set forth.

Testing of the monitored pilings produced by the assignee has shown the effectiveness of monitoring the pilings while driving to provide real time feedback to the hammer or crane operator in order to selectively control hammer energy and optimize the efficiency of the pile installation process. This information is also be used to prevent overdriving and subsequent pile failure by reporting and providing feedback of the absolute allowable strain readings and ranges present within the material. However, further improvements are desired.

Until now, pile monitoring has been designed or tailored specifically to assess the integrity of driven piles, specifically during the installation process for piling length below grade. This is important because many times the pile tip is exposed to very large, potentially damaging driving and shear forces especially when being driven into harder materials; and there is no practical way to visually inspect for pile damage except for pile removal. Because of this current lack of visual inspection capability and the expectation of pile integrity for load bearing design purposes, there is a need for a simple, lower cost and automatic method for pile tip integrity monitoring during installation.

Additionally, in view of the desirability of now monitoring all pilings being driven for bridges and other structures, it would be beneficial to reduce the costs associated with monitoring all pilings.

### SUMMARY

A pile having first and second strain gauges installed in the piling core near and at the piling tip is provided. The second strain gauge is placed co-linear and at a known and controlled distance up the pile from the first strain gauge. Independent strain gauge measurements are made and transmitted to a controller, which receives signals from the strain gauges and compares them to static pre-stress levels that are initially established and recorded after casting and prior to pile installation. The dynamic force measurements are checked against expected absolute and relative/differential ranges to assess pile tip integrity as well as other parameters.

A method of monitoring a piling made according to the invention during driving is also provided. Here, data is provided to the controller for X, d, pile length, and at least one of acceptable stress ranges, differential stress limits or wave speed range and differential limits. A pre-load static stress is measured at the first and second strain gauges. The dynamic stress data is transmitted from the first and second strain gauges to the controller for a pile driving hammer blow. Using the controller, a resulting dynamic tip stress from the first strain gauge is compared to the reference pre-load static stress and to a corresponding dynamic reference stress from the second strain gauge for determining a differential tip static stress shift and a differential reference stress. These are checked against predetermined limits to assess pile tip integrity. If the limits are exceeded, a signal is provided to the operator.

### BRIEF DESCRIPTION OF THE DRAWING(S)

The foregoing summary, as well as the following detailed description of the preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements shown.

FIG. 1 is a perspective view of a pile according to the invention.

FIG. 2 is an enlarged view of the tip end of the pile of FIG. 1, showing a vertical crack.

FIG. 3 is a view of the pile according to the invention during driving.

FIG. 4 is a view of the removable radio module.

FIG. 4A is a view of a removable recording module.

FIG. 5 is a flow diagram for a preferred method of monitoring pile driving.

FIGS. 6 and 7 are graphs showing piling data gathered during driving of a pile where failure occurrence was detected using the invention

### DETAILED DESCRIPTION OF THE PREFERRED EMBODIMENT(S)

Certain terminology is used in the following description for convenience only and is not considered limiting. The words “lower”, “upper”, “left” and “right” designate directions in the drawings to which reference is made. As used herein, the recitation of “at least one of A, B, or C” means any one of A, B, or C or any combination thereof, where A, B, and C represent the noted features of the invention. Additionally, the terms “a” and “one” are defined as including one or more of the referenced item unless specifically noted.

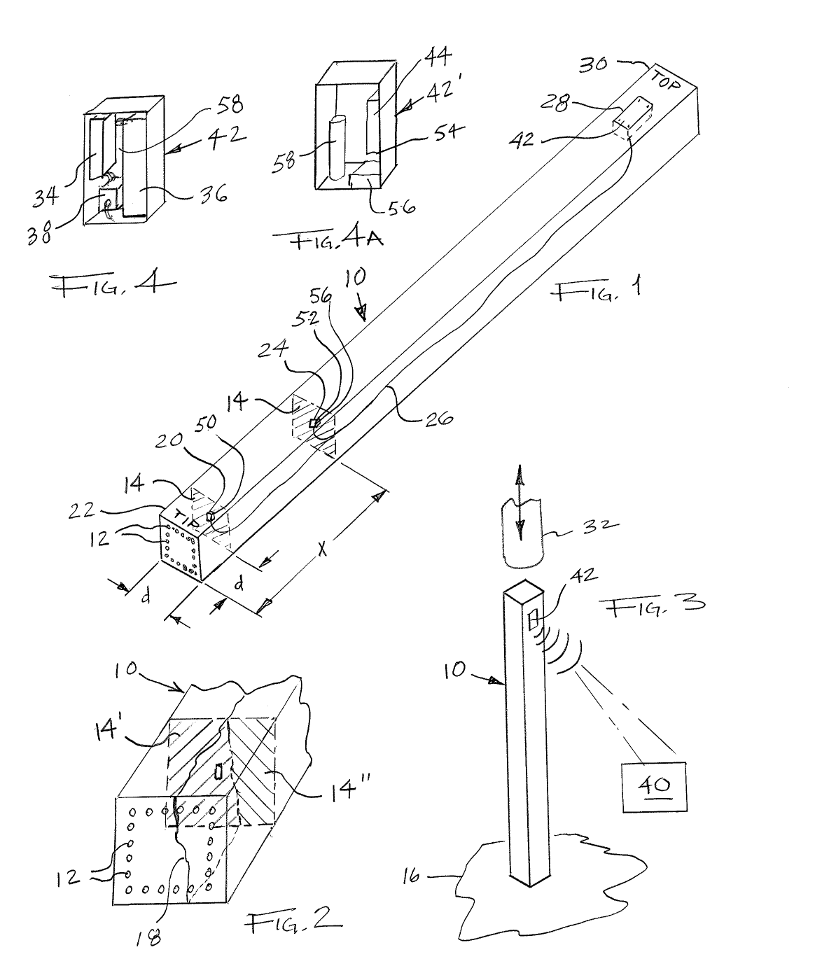

Referring to FIG. 1, a pile 10 according to the invention is shown. It is formed generally in the known manner using pre-stressed strands 12, and has a defined cross-sectional area 14. Prior to casting, a first strain gauge 20 is placed at a pile diameter d from the tip end 22, preferably at a mid-point in the cross-sectional area 14. A second strain gauge 24 is placed a fixed distance X from the tip 22, which is preferably less than 50% of the piling length. The strain gauges 20, 24, or strain gauges set to provide equivalent measurements, are located co-linearly, and are connected via wires 26 located within the pile to a receptacle box 28 recessed into a side of the pile near the top 30.

After the pile 10 is cast and the strands 12 are cut, the resulting pile pre-stress is a balance or equilibrium condition between the total force of the strands 12 pulling inward, and the uniform force spread across the cross-sectional area 14 of concrete pushing outward to its natural cast state. The two opposing forces eventually balance and reach the resultant pile pre-stress. The pile pre-stress is not fully developed at a distance less than 2d from the top or the tip, and accordingly, there can be a slight difference in the measured pre-stress reading between the strain gauges 20, 24 based on the location of the gauge 20 at 1d from the tip. If anything happens to upset this balance, a change in measured static pre-stress, either up or down, results. If the pile 10 experiences vertical cracking 18, see FIG. 2, the cross-sectional area and subsequent balance is affected. At a minimum, (as viewed looking into the end) the pile 10 end will have at least two sections 14′, 14″. The resulting pre-stress for each section 14′, 14″ will be determined by the sections cross-sectional area, and the amount of strands 12 present or remaining in the section 14′, 14″.

Any non-symmetric crack 18 relative to the pile tip end 22, such as shown in FIG. 2, will result in some sort of static pre-stress shift, dependant on the factors above. A symmetric crack can also be detected by the loss of the core located measurement system. A complete loss of measured static pre-stress indicates the potential for or actual complete separation of the pile core (location of the measurement system within the strands 12) from the strands 12. The complete loss of static pre-stress is an extreme event which should eventually be followed by higher tensile stresses due to large force wave reflections caused by a crumbling pile tip end 22 during heavy driving. However, any significant change in static pre-stress, and especially losses in compressive preload, during driving are, according to the invention, noted as a possible leading edge indicator of pile tip damage including vertical cracks 18. A larger measured static compressive force (residual stress) at the pile tip, however, could be the result of the weight of the pile 10 plus any below grade (indicated at 16 in FIG. 3) soil skin friction forces preventing tip rebound from a hammer blow by a pile driving hammer 32. The measurement of static stress at the second strain gauge 24 compared to the first strain gauge 20 helps to discern pile tip damage against signs of residual stress conditions.

According to the invention, the amount of pre-stress shift is ultimately weighted into an updated pile integrity factor. Changes in measured wave speed during the course of driving can also be used to determine the severity of the material stress condition.

Prior to the invention, vertical cracking 18 was non-detectable using the conventional and more traditional testing method of using the presence of early reflections to indicate pile tip end damage. This appears to be why comparative results did not correlate well in some instances. Cracking caused by high tension conditions are typically oriented orthogonal to vertical cracks and may not result in a change in pre-stress condition. These types of cracks also typically occur further up from the pile tip in the pile 10, and are usually detectable using traditional early reflection analysis approaches.

According to the invention in its simplest form, the two separate and independent strain gauges 20, 24 are located/installed in the piling core near and at the piling tip 22. The first strain gauge 20 is placed very close to the pile tip 22, and preferably within one diameter d from the pile tip 22 at a mid-point of the cross-sectional area 14. The second strain gauge 24 is placed co-linear and at a known and controlled distance X up the pile 10 from the tip 22, past the first strain gauge 20 in the direction towards the pile top 30. This controlled distance X is preferably 5 to 20 feet, and more preferably 10 to 15 feet from the tip 22. The actual distance X will vary dependent on the pile design, in view of factors such as pile diameter d and overall length. The present approach utilizes independent strain gauge measurements and relative comparisons (both static and dynamic), with the gauge 24 furthest away from the tip 22 being the reference measurement. The strain gauges 20, 24 conditioning electronics transmit data via the wires 26 to a removable self powered data collector/signal conditioner 34 and transmitter 36 located in the receptacle box 28 which is located a controlled distance and orientation, preferably 2d, down from the pile top. This controlled distance is preferably also stored in the memory. Preferably an accelerometer 38 is also included with the self powered data collector/signal conditioner 34 and transmitter 36 that are engageable in the receptacle box 28. The data collector 34 is preferably a programmable controller with a non-volatile memory and power source 58. The transmitter 36 can be of any known or proprietary type of wireless signal transmitter, and can be preferably for example based on blue tooth or WiFi technology, and is connected to the data collector 34 to transmit a data signal to a remote controller 40. Preferably, the data collector 34, the transmitter 36 and the accelerometer 38 are assembled along with a battery 58 as a separate self-contained, removable and re-useable wireless data interface module 42, shown in FIG. 4, that can be easily installed and removed from the receptacle box 28 in the pile 10 for re-use, and a simple snap-in plug connection (or other suitable connection) is provided for the wires 26 coming from the strain gauges 20, 24, and more preferably from the conditioning electronics associated with the strain gauges 20, 24.

The controller 40 receives signals from the strain gauges 20, 24 and compares relative static pre-load stress levels that are initially established after casting (preferably by measurement) and prior to pile installation, which are continually monitored, and the dynamic force measurements against expected ranges to assess pile tip 22 integrity as well as other parameters.

After impact from a pile driving hammer 32, a compression wave propagates down the pile 10 past the reference gauge 24 and on to the tip gauge 20 a fixed distance (X-d) away. The time or phase delay between the incident wave measurements can be used to determine and confirm wave speed or velocity against allowable ranges. Alternatively, it is possible to measure the time or phase delay of the compression wave from the reference gauge 24 as the compression wave reflects from the tip back to the top past the gauge 24 and then reflects from the top back to the reference gauge 24 to confirm the wave speed or velocity. This provides a known fixed distance from the pile top to the reference gauge 24 to measure/confirm the wave speed that would more likely not be affected by the tip being damaged.

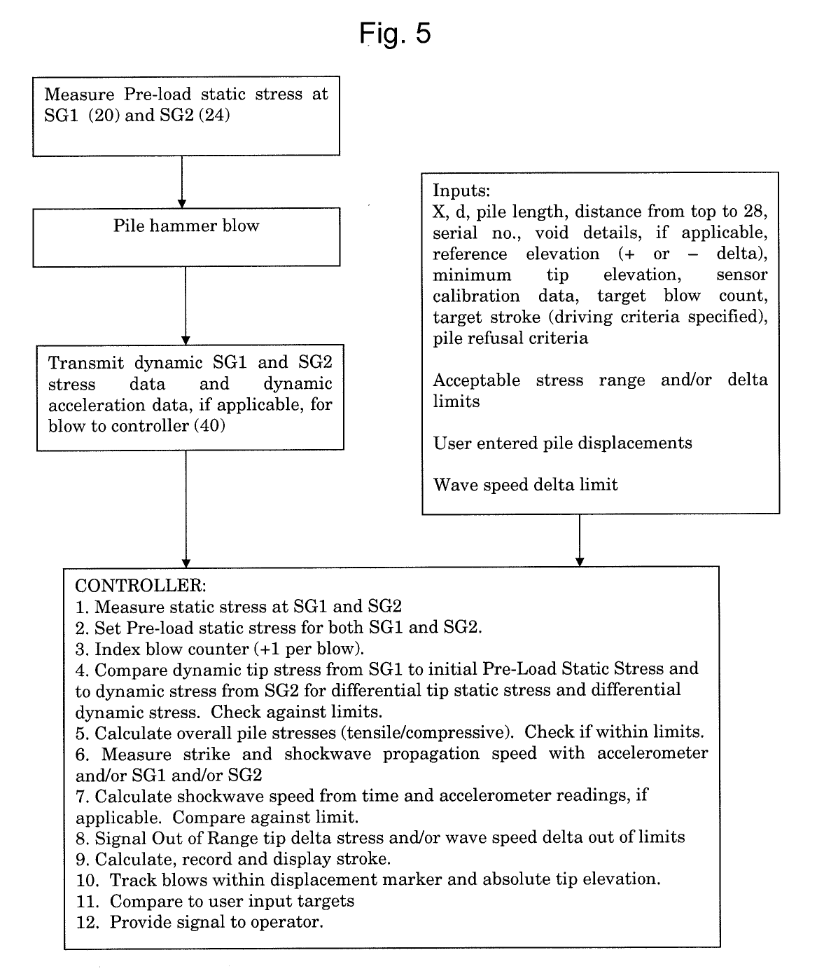

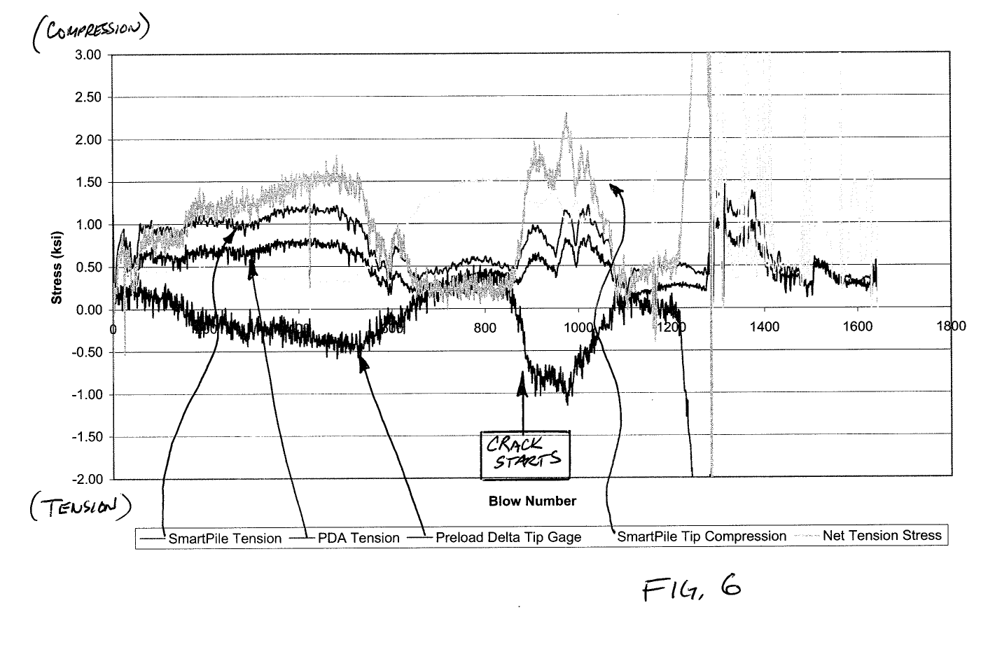

The accelerometer 38 contained in the wireless data interface module 42 can be preferably used as a reference point to measure the phase delay timing at the tip instrumentation (strain gauges 20, 24) in order to track/monitor wave speed with higher precision. The tip strain gauge 20 will experience a reflected upward force wave component shortly after the measured downward wave. This will result in the summation of the downward and the delayed reflected upward component waves being measured by the strain gauge 20 at the tip 22. This is then accounted for in the comparison, using the second strain gauge 24 as a reference for the non-superimposed peak portion of the downward and upward reflected impact wave. This can also be used to determine material density differences present or energy lost at the pile end boundary. Depending on the pile tip soil conditions, the summation of reflected strain component almost immediate to peak strain of the downward wave, causes the pile tip 22 to be susceptible to compressive force damage during heavy pile driving. The dynamic forces measured at the two separate locations of the gauges 20, 24 are calculated from the measured strain multiplied by the material modulus of elasticity multiplied by the cross-sectional area 14. The invention relies on the fact that the modulus, area and static pre-stress, once known, should remain fairly constant at both measuring positions (assuming nominal and reference tracking variations in residual stresses), the comparison focuses on properly phased and area compensated strain or force measurements. A flow diagram for one preferred method of monitoring pile driving of the pile 10 is shown in FIG. 5. SG1 and SG2 refer to the first and second strain gauges 20, 24.

Different cross-sectional areas 14 due to pile design variations can also be accounted for in the comparison. For example, if the areas 14 indicated in FIG. 1 at the strain gauges 20, 24 varied, this could be accounted for by using the actual cross-sectional area at each location. It is also possible to use separate and averaged strain gauge measurements instead of a single centroid reference measurement in the case of voided piles with a solid tip. The converse for a voided tip condition and other combinations are also possible.

The comparisons in the controller 40 check if the differences between the independent strain/force measurements are within an acceptable range (accounting for the conditions described above). A measured shift or loss of static pre-load stress reference levels during driving indicates a potential separation of the concrete material from the pre-stressed strands 12. A significantly higher than expected difference in strain readings not explained by the strain wave down-up superposition could indicate a damage induced change in cross sectional area due to a damaged pile tip 22, for example a crack 18 as shown in FIG. 2. In either event, it is diagnosed or reported as a potential pile tip 22 failure.

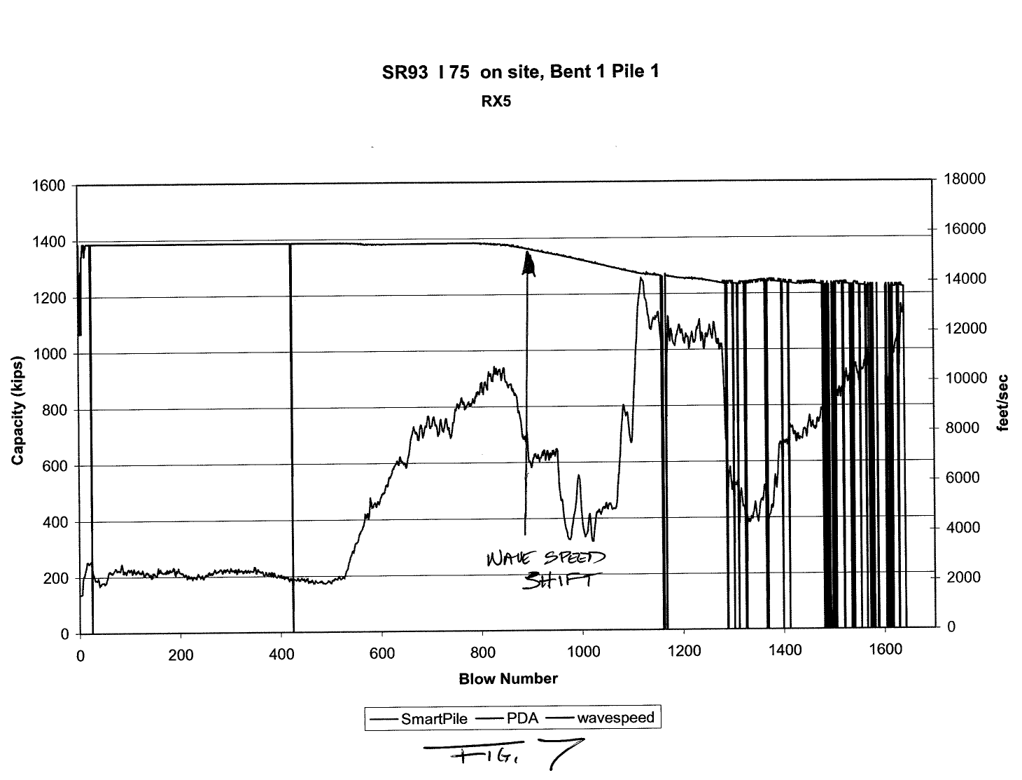

Test Data from a pile having a length of 80 feet and a dimension d of 24 inches is shown in FIGS. 6 and 7. The differential in strain from the static pre-load strain is indicated for the tip gauge 20, and shows a steep drop-off at about 900 blows (actual start of drop was blow 892 per tracking data). Total tip failure became evident at about 1200 blows. The wave speed measurement of FIG. 7 also indicates a wave speed drop-off at the same point, where it is believed that the initial cracking began. The present system predicted the failure 25% earlier than the prior systems using the differential pre-stress strain measurement at the tip gauge 20. This means the pile could have been extracted and replaced earlier, possibly saved, or driving discontinued earlier in favor of a new pile, saving time and expense.

The present system in its simplest sense uses two embedded strain gauges 20, 24 preferably with co-located conditioning electronics internally connected to an externally accessible low-profile flush mounted receptacle box 28 located on the pile face approximately two diameters down from the pile top 30 for accepting a self-powered gauge signal and wireless data interface module 42. Optionally, another accelerometer can be located down with the tip strain gauge 20 or reference strain gauge 24 that can be used in conjunction with the accelerometer 38 at the top of the pile 10 in the module 42 for improved precision on wave speed monitoring or additional wave mechanics calculations. Alternatively, acceleration and velocity can be derived by the controller 40 using data produced by the strain gauges 20, 24 located a fixed distance X-d apart or from one of the strain gauges using the top reflection surface of the piling and a known distance to the strain gauge. Data from the internal system is transmitted from the pile 10 using preferably a self-powered, data interface module 42 containing the transmitter 36 (or optionally, the transmitter or radio can be embedded in the pile) to the controller 40, which can be a handheld or portable computer device operated by a pile inspector to count, record, and display hammer stroke, blows and blows per unit displacement, measured dynamic displacement at the pile tip 22, measured displacement at the pile top using accelerometer 38 including pile refusal, measured peak and residual tip stresses, measured pile 10 tensile stresses, as well as track and record pile penetration and measure, track, and record wave speed, and serves as an electronic record device for production pile installation and quality assurance, among others. The controller 40 also automatically flags the inspector in the impending case or event of a pile refusal condition or if a potential pile or pile tip failure condition is detected, (through a combination of wave speed and stress and differential strain/stress monitoring). Since the wirless data interface module 42 is removable and re-useable, the cost for manufacturing the pile is reduced in comparison to prior internally instrumented and monitored pilings.

As a further benefit, the system also provides for post construction monitoring of strain loading and the potential loss of pre-stress beyond just the pile installation, and provides the ability for long term monitoring by connecting a long term monitoring device or connection to the strain gauge 20 and/or 24 in order to detect changes in or a loss of measured strain. This can indicate a de-lamination due to internal strand corrosion or scour depending on the condition. Strain gauges 20, 24 also provide insight into vertical loading distribution/load transfer including some level of redundancy for added measured data integrity.

In a further alternative embodiment of the invention, internal temperature sensors 50, 52 are preferably provided along with one or both of the strain gauges 20, 24, as indicated in FIG. 1. A temperature sensor 54 is also located in a recording module 42′ that includes a processor 44, non-volatile memory, the temperature sensor 54 and a battery 58, as shown in FIG. 4A. The recording module 42′ is connected in the receptacle box 28 just prior to pile casting. The temperature sensors 50, 52, 54 allow a differential curing profile (core vs. pile skin) to be recorded/generated by the processor, as well as the processor also measuring and recording the pile pre-stress at the time the strands 12 are cut. The differential curing profile results along with the measured pre-stress can be stored in a non-volatile memory 56 located in the pile 10, for example with one of the strain gauges 20, 24 conditioning electronics or as a fixed memory installed as part of the receptacle box 28. Additionally, dimensional details data of the piling 10 and any sensor calibration data along with a unique pile 10 serial number can also be stored in the memory 56. This data is then readily available to the controller 40 of the data interface module 42 for the specific piling 10 during installation of the piling 10.

During pile installation, the data interface module 42 is engaged in the receptacle box 28, as noted above, and the controller 40 can access the pile 10 unique serial number, manufacturing and sensor placement dimensions, curing profile results, sensor calibration data and pile 10 pre-stress stored in the non-volatile memory 56, which are used in connection with generating stress/strain monitoring set points and limits as well as to check for data trends and correlation. It is also possible to just include the temperature sensor 54 in the data interface module 42 so that a separate recording module 42′ is not required and the data interface module 42 can serve both functions. If cost effective, the processor 44 and non-volatile memory components of the recording module 42′ can be included with the gauge conditioning electronics (adding the temperature sensor 54 with the receptacle box 28 in order to still provide the cure monitoring function), resulting in the recording module 42′ only including a removable battery.

The current invention could be used along with the traditional method of driven pile installation using a Driving Criteria. It is also possible to use less hardware in some of the piles being used at a certain site once the driving criteria are established by fully monitored pilings 10 available from the assignee. The controller 40 would track the pile 10 (absolute) tip elevation relative to user input reference elevation data, and dynamic user recorded pile penetration data relative to the reference elevation. Once the user input (also Driving Criteria specified) minimum pile 10 tip elevation is achieved, the controller 40 would signal the operator when the user input (stroke compensated) blow count condition requirements specified in the Driving Criteria or pile refusal have been met. It is possible to use the peak force as measured at the pile top using the accelerometer 38 derived velocity multiplied by pile impedance to normalize calculated results for effects of an aging piling cushion in terms of hammer energy transfer efficiency. Once the minimum pile 10 tip elevation and stroke compensated blow count requirements or pile refusal are met AND no fault conditions have been detected using the system instrumentation, pile installation is acknowledged as successfully completed.

A simple (off)-red-yellow-green light signaling scheme on the controller 40 can be provided; one light each for:
Fault (damage)—off/red
Stresses—green/yellow/red
Min tip elevation—off/yellow (close)/green (met)
Blow count (stroke comp.)—off/yellow (close)/green (met)
Pile Refusal—off/green
   With green indicating all's-well, yellow indicating/warning the approach of set-points/limits, and red indicating a problem. They would automatically signal the operator in successive fashion for simplified results interpretation. The goal would be to never have the fault light turn on, and have all remaining lights turn (remain) green as installation proceeds to completion (3 greens) with pile refusal and blow count being either/or.

The system described above is not limited by this configuration, and many approaches within the scope of the invention would yield similar results. As a result, this invention is uniquely suited to provide levels of quality control not realizable using existing test methodologies.

While the preferred embodiments of the invention have been described in detail, the invention is not limited to the specific embodiments described above, which should be considered as merely exemplary. Further modifications and extensions of the present invention may be developed, and all such modifications are deemed to be within the scope of the present invention as defined by the appended claims.

1. A pile comprising:
pile strands;
concrete located around the strands which forms a concrete piling core;
first and second strain gauges cast into the piling core near and at a piling tip, the first strain gauge located a distance d from the tip, the second strain gauge is placed co-linear and at a known and controlled distance X up from the piling tip;
a transmitter connected to the pile adapted to transmit independent strain gauge measurements from the strain gauges; and
a controller, which is adapted to receive signals from the first and second strain gauges and compares them to static pre-load stress levels in the piling established prior to and/or during driving, and compares dynamic force measurements against expected ranges to assess pile tip integrity.

2. The pile of claim 1, wherein the controlled distance X is less than 50% of the piling length.

3. The pile of claim 1, further comprising a self powered data collector/signal conditioner connected with the strain gauges and the transmitter, the self powered data collector/signal conditioner and the transmitter being removably located in a receptacle box at a top of the piling.

4. The pile of claim 1, wherein the controller is adapted to determine a time or phase delay of a wave speed through the pile using signals from the first and second strain gauges and the controlled distance X and the distance d relative to an overall piling length or using an accelerometer connected to the pile at a known distance from the pile top.

5. The pile of claim 1, wherein the controller is adapted to compare a dynamic tip stress from the first strain gauge to an initial Pre-Load Static Stress and to a dynamic stress from the second strain gauge for a pile driving blow to determine a differential tip static stress and a differential dynamic reference stress.

6. The pile of claim 5, wherein the controller is adapted to check the differential tip static stress and the differential reference stress against known limits.

7. The pile of claim 5, wherein the controller is adapted to calculate an overall pile stress for a pile driving blow.

8. The pile of claim 1, wherein the controller is adapted to compare a dynamic tip stress from the first strain gauge to a dynamic stress from the second strain gauge for a pile driving blow to determine a differential dynamic stress.

9. The pile of claim 1, further comprising a memory located in the pile that is adapted to store at least one of a measured pre-stress in the piling, piling dimensions, gauge calibration data and a unique piling identification.

10. The pile of claim 1, further comprising an accelerometer connected to the piling.

11. A method of monitoring a piling during driving, comprising:
providing a pile including pile strands, concrete located around the strands which forms a concrete piling core, first and second strain gauges cast into the piling core near and at a piling tip, the first strain gauge located a distance d from the tip, the second strain gauge is placed co-linear and at a known and controlled distance X up from the piling tip that is less than 50% of a piling length, a transmitter connected to the pile adapted to transmit independent strain gauge measurements from the strain gauges, and a controller, which is adapted to receive signals from the first and second strain gauges;
providing data to the controller for X, d, the piling length, and at least one of gauge calibration data and a unique piling identification;
measuring a pre-load static stress at the first and second strain gauges;
transmitting stress data from the first and second strain gauges to the controller for a pile driving blow;
using the controller to compare a dynamic tip stress from the first strain gauge to the pre-load static stress and to a dynamic stress from the second strain gauge for determining a differential tip static stress and a differential dynamic stress, and checking the differential tip static stress and the differential dynamic stress against known limits to assess pile tip integrity; and
providing a signal if the limits are exceeded.

12. The method of claim 11, further comprising:
using the controller to calculate overall pile stresses and checking if the overall pile stresses are within the acceptable stress ranges.

13. The method of claim 11, further comprising:
using the controller to calculate a shock wave propogation speed using the signals for at least one of the first and second strain gauges or an accelerometer connected to the piling, and the data for X, d and the pile length and a distance of the accelerometer from the piling top, and comparing the shock wave propogation speed against the wave speed delta limits.

14. The method of claim 11, further comprising:
using the controller to calculate, record and display stroke data for each pile driving blow.

15. The method of claim 11, further comprising:
using the controller to signal operator status using a visual indicator.

16. The method of claim 15, wherein the visual indicator includes lighting a red indicator light if the differential tip static stress or the differential dynamic stress exceed the known limits.

17. The method of claim 11, further comprising:
using the controller to track pile tip elevation using user input displacements and reference elevation data.

18. The method of claim 11, further comprising:
using the controller to calculate peak force transfer versus stroke to assess pile cushion transfer efficiency and derive stroke compensated values.

19. The method of claim 11, further comprising:
using the signal from the second strain gauge as a reference for a non-superimposed peak portion of a downward and upward reflected impact wave.

20. The method of claim 11, further comprising:
measuring wave speed from a top reflection surface of the piling using one of the strain gauges.
